(19) United States
(12) Patent Application Publication
(10) Pub. No.: US 2026/0002319 A1
(43) Pub. Date: Jan. 1, 2026

(54) ARTICLE TRACKING

(71) Applicants: The Regents of the University of Michigan, Ann Arbor, MI (US); Massachusetts Institute of Technology, Cambridge, MA (US)

(72) Inventors: Brian Iezzi, Ann Arbor, MI (US); Max Shtein, Ann Arbor, MI (US); Tairan Wang, Lexington, MA (US); Mordechai Rothschild, Newton, MA (US); Austin Coon, Cambridge, MA (US); Lauren Cantley, Cambridge, MA (US); Bradford G. Perkins, Arlington, MA (US)

(21) Appl. No.: 18/992,498

(22) PCT Filed: Jul. 6, 2023
(86) PCT No.: PCT/US2023/027003

§ 371 Date: Jan. 8, 2025

Related U.S. Application Data
(60) Provisional application No. 63/359,615, filed on Jul. 8, 2022.

(51) Int. Cl. D06H 1/04; D01D 5/32; G06K 19/06

(52) U.S. Cl. CPC D06H 1/043; D01D 5/32; G06K 19/06046

(57) ABSTRACT

An article includes an identifier fiber. The identifier fiber includes a photonic structure that, upon illumination, produces an optical response having an optical parameter value. The optical parameter value, at least in part, identifies a particular article characteristic. The inclusion of the identifier fiber in the article indicates, at least in part, that the article has the particular article characteristic.

### PRIORITY

This application claims priority to U.S. Provisional Application No. 63/359,615, filed Jul. 8, 2022, and titled Article Tracking, which is incorporated by reference herein in its entirety.

### STATEMENT ON GOVERNMENT SUPPORT

This invention was made with government support under 1727894 awarded by the National Science Foundation and under FA8702-15-D-0001 awarded by U.S. Air Force. The U.S. government has certain rights in the invention.

### BACKGROUND

### Technical Field

The disclosure relates generally to article tracking.

### Brief Description of Related Technology

Articles, such as those made from textiles, may be tracked at various stages of manufacture, use, and disposal. In some cases, article tracking elements such as label, tags, or barcodes may become degraded during the lifecycle of the article. This may present challenges at various stages in the life cycle. For example, the base makeup of textiles may be unknown. This may render the textiles unsuitable for garment manufacture and/or recycling at later stages in the textile lifecycle. Intentional degradation of labeling may be used to facilitate counterfeiting of branded articles. Thus, improvements to the robustness of article labeling and tracking will continue to drive industry adoption of labeling and tracking solutions.

### BRIEF DESCRIPTION OF THE DRAWINGS

FIG. 1 shows an example article.

FIG. 2 shows an example fiber read system.

FIG. 3 shows example fiber read logic.

FIG. 4 shows an example fiber read execution environment.

FIG. 5 shows example fiber lookup logic.

FIG. 6 shows an example fiber lookup execution environment.

FIG. 7 shows an example method of manufacture for an identifier fiber.

FIG. 8 shows an example coding scheme.

### DETAILED DESCRIPTION

In various contexts, an article, such as a garment, durable good, textile, material sheet, or other product, may rely on identifying markings at various stages in the lifecycle of the article. In some cases, markings, such as labels, tags, barcodes, and/or other localized identifier markings attached to discrete portions of the article, may become degraded and/or detached from the article and/or severed portions of the article. The loss of such marking may inhibit article resale, recycling, use in manufacturing, authenticity verification and/or other effects on article usefulness/viability. The techniques and architectures discussed herein provide for the embedding of long-lived article identifying and marking features. The techniques and architectures provide for an identifier fiber including a photonic structure (e.g., a one-dimensional photonic crystal and/or other elongated photonic structure) that extends along the length of the fiber. The photonic structure may have a selected optical response that may be measured by illuminating the identifier fiber and measuring a parameter value of the response, such as a center frequency of a band of the response, the width of a band of the response, a peak-to-peak separation of overtones associated with photonic structure, and/or other parameter values. The parameter values may be referenced against a database to determine the characteristics to which the parameter values are assigned as identifiers.

In various implementations, the optical response may be, at least in part, dependent on the structural features of the photonic structure as opposed to being dependent only on the materials making up the identifier fiber. Thus, the lifetime stability of the optical response may be similar to the robustness of the structure itself. Accordingly, the photonic structure as an identifier may be robust to various forms of degradation such as fading, photobleaching, or other degradation of response. Additionally or alternatively, because the identifier fiber can be robustly embedded into an article (e.g., by weaving, threading, sewing, and/or other fiber inter-stitching), the identifier fiber may be robust against material erosion, sluff-off, and/or other wear effects. Additionally or alternatively, because the identifier fiber includes an elongated photonic structure, the optical response may be robust against severing and/or localized fissures within the photonic structure. The photonic structure may be disrupted in the immediate area of a tear or fissure, but the majority of the length of the photonic structure may remain intact. Because virtually any portion of the length of the photonic structure may be used to produce the intended optical response, the localized break in the structure may have limited effect. Therefore, the photonic structure may, for example, survive article rendering during disposal, which, for less robust solutions, may result in the article being rendered non-recyclable and/or increase the costs associated with article recycling or disposal.

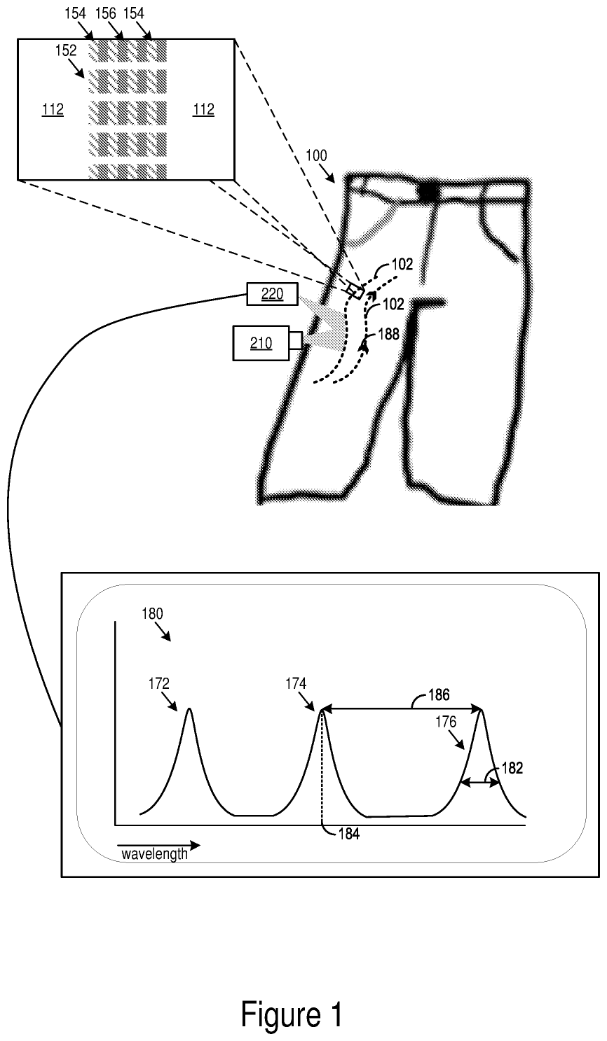

FIG. 1 shows an example article 100. Identifier fibers 102 are embedded in the example article 100. The example article 100 may be fashioned from textiles, which may be made up of base material fibers 112. The base material fibers 112 may make up the bulk of the textile mass, while the identifier fibers 102 may contribute a smaller portion. In some cases, the identifier fibers 102 may contribute a negligible portion of the mass of the textiles that makeup the article 100. Other articles, such as those made from non-woven textiles and/or those not made from textiles may have embedded fibers. For example, leather textiles, spun polymer sheets, and/or other non-woven materials may have identifier fibers stitched into the material, stapled, point adhered by heating, and/or otherwise embedded.

The identifier fiber 102 may include an elongated photonic structure 152. For example, the photonic structure 152 may include a one-dimensional (1-D photonic crystal structure). The photonic structure 152 may include nano- and/or microscale features (e.g., across one dimension of the photonic structure 152) while the photonic structure 152 may be macroscale in length. The photonic structure 152 is shown woven along with the base fibers 112. As an illustrative example, the photonic structure 152 is shown with alternating material layers 154, 156 of uniform optical thickness (e.g., refractive index times thickness). Accordingly, the example photonic structure may act as Bragg reflector for light for a fundamental wavelength A corresponding to about two times the uniform layer optical thickness (and/or the corresponding odd overtones—λ/3, λ/5, λ/7, λ/9, . . . , λ/2N+1). Overtones occur at integer fractions of the fundamental reflected wavelength. However, when the optical thickness of alternating layer is uniform, the even overtones destructively interfere for the reverse-propagating field resulting in transmission rather than reflection. When the thicknesses of the alternating layers diverge, both even and odd integer overtones may also be reflected (e.g., λ/2, λ/3, λ/4, λ/5, . . . , λ/N). However, divergent layer optical thicknesses may result in broader reflective features and reduced peak reflectance. In various implementations, using photonic structure features in the infrared spectrum, layer optical thicknesses ranging from 400 nanometers (nm) up to 10 microns (μm) or more may be used to produce fundamental and/or overtone reflective features at wavelengths throughout the infrared spectrum. Because different materials may have different indices of refraction, two different material layers may differ in actual thickness, but have the same optical thickness. In some cases, complex index of refraction may be used in planning and designing a optical parameter response. For example, if there is a large extinction coefficient at a specific wavelength then there will be a drop in reflected light intensity due to attenuation. Thus, “valleys” in reflectance may be used as optical parameters in addition to peaks.

However, other photonic structures may be used, for example the alternating material layer stack may be rolled into concentric layers such that the reflectivity of the structure may be independent of the incidence angle of illumination. In an example, various different material layer patterns (which may be repeating or non-repeating) may be used. Photonic structures with air gaps may be used. Doped layers and/or other doped regions may be used. Metal materials may be used. Semiconductor materials may be used. Glass materials (e.g., silica glass, chalcogenides) may be used. Polymer materials may be used. Birefringent materials may be used. In an example, the photonic structure may include a dispersive grating structure (e.g., with changing layer spacing across the photonic structure) to effect phase matching to facilitate wave mixing and/or other nonlinear optical responses.

In an illustrative example, polymer materials such as polycarbonate (PC), polymethyl methacrylate (PMMA), polystyrene (PS), polyethylene terephthalate (PET), poldimethylsiloxane (PDMS) may be stacked in layers to form a Bragg reflector. The materials may be selected for structural properties such as flexibility, tensile strength, compatibility with article manufacturing processes and/or optical properties such as refractive index, material dispersion, nonlinear response, and/or other optical properties. As an illustrative example, materials may be selected based on relative refractive index contrast. For example, using alternating uniform thickness layers of two materials with relatively lower refractive index contrast may be used to create a Bragg reflector with a narrower band of reflectivity (for a given number of layers). Conversely, alternating uniform thickness layers of two materials with relatively higher refractive index contrast may be used to create a Bragg reflector with a wider band of reflectivity (for a given number of layers). Other optical parameters may be controlled (at least in part) through photonic structure material selection. As noted, some optical parameters may depend on the materials used to construct the photonic structure. However, the photonic structure may also depend on the structure pattern of the photonic structure. For example, the uniform thickness of the alternating material layers may determine the center position of the reflection band of the Bragg reflector.

Additionally or alternatively, the number layers included in the Bragg reflector may be used to control the peak reflectivity of the Bragg reflector. Increasing the number of layers may increase the reflectivity of the Bragg reflector. However, increasing the number of layers may also increase the thickness of the identifier fiber for a given layer thickness. Accordingly, the number of layers may be selected for reflectivity and/or mechanical attributes (tensile strength, flexibility, similarity to surrounding base fibers, and/or other mechanical attributes).

Upon illumination by an illuminator 210, the photonic structure 152 may provide an optical response 180 captured by an optical sensor 220. The optical response 180 may have various features 172, 174, 176, for example, characterized by optical parameter values 182, 184, 186, e.g., a bandwidth 182 of band present in the optical response, a center position 184 (e.g., in frequency or wavelength) of a band, a peak-to-peak separation 186 of bands present in the response, and/or other characterizable optical response features. The optical parameter values 182, 184, 186 may be referenced against a database relating optical parameter values to article characteristics to determine the characteristics identified by the specific optical parameters of the photonic structure. In various implementations, other optical parameters may be used such as dopant concentration/content, incident-light-angle response dependence or other optical parameters. In various implementations, the optical parameters may include parameters of the photonic structure, such as layer-to-layer spacings, other pattern spacings, material makeup, or other parameters of the photonic structure.

The optical parameter values 182, 184, 186 may be positioned within a parameter space. For example, the parameter space of the center position 184 may be a frequency/wavelength space. For example, the parameter space of a layer thickness may be as set of possible distances between layers. Thus, when characterizing an optical parameter value, a system may perform a characterization that covers at least a portion of the parameter space of the optical parameter being characterized to determine where the optical parameter lies within that parameter space.

In various implementations, the article characteristics identified by the identifier fibers may vary. For example, the characteristics may include information regarding the material makeup of the article, such as the fiber context (e.g., X percent cotton, Y percent nylon, . . . or other material makeups). For example, the characteristic may include an identity of the article, such as a product number for a garment or other product, an article-specific serial number, a stock keeping unit (SKU), a universal product code, and/or other identity for the article. For example, the characteristic may include background, supply chain, and/or logistical information for the article, such as a manufacturer for the article, a supplier for a material in the article, a manufacture date for the article, a shipment tracking identifier, a logistics reference number, or other background information. For example, the characteristic may include information for disposal and/or recycling, such as a recycling sorting reference number (e.g., similar to such markings for plastics), instructions for safe disposal handling, and/or information regarding composting and/or biodegradability. For example, the characteristic may include information for care of the article, such as instructions for cleaning, washing, and/or other article upkeep.

In various implementations, the optical response 180 of the photonic structure 152 may be characterized via a scanning technique such as scanning over multiple illumination frequencies, scanning a filter over multiple response frequencies, scanning over multiple incidence angles, scanning over multiple illumination phases, and/or other scanning. In an illustrative example, the identifying optical parameter values 182, 184, 186 of the optical response 180 may include values measured from features of the optical response in the infrared spectrum. Accordingly, techniques such as Fourier Transform infrared (FTIR) spectroscopy may be used to extract the optical parameter values from the optical response 180.

In some cases, the features 172, 174, 176 of the optical response 180 used to indicate the optical parameter values 182, 184, 186 may include features selected in part based on the position within the detection range of particular optical sensors. For example, a feature may be selected because it lies within the detection range of a silicon-semiconductor-based optical sensor. For example, a feature may be selected because it lies within the detection range of an indium-gallium-arsenide-semiconductor-based optical sensor. For example, a feature may be selected because it lies within the detection range of a mercury-cadmium-telluride-based optical sensor. In some cased germanium semiconductor-based optical sensors may be used. Silicon sensors may be widely available (e.g., nearly ubiquitous due to their common inclusion in many mobile devices) and relatively lower in price than other detectors. Accordingly, various implementations, may select/tune identifying features to lie within the detection range of silicon-semiconductor-based optical sensors. Indium-gallium-arsenide-semiconductor-based optical sensors may be relatively lower priced than mercury-cadmium-telluride-based optical sensors. Accordingly, in some implementations, positioning of an identifying feature within the detection range of an indium-gallium-arsenide-semiconductor-based optical sensor may allow for lower overall system cost than a mercury-cadmium-telluride-based optical sensor but a somewhat higher overall system cost than a silicon-semiconductor-based optical sensor. Detector response times, refresh times, and/or cooling requirements are considered in sensor selection.

The multiple identifier fibers 102 may provide redundancy and/or allow for additional “symbol” coding for identifiers. For example, multiple fibers each with one or more corresponding optical parameters may be included in the article 100. In some implementations, two or more of the multiple fibers may have the same optical parameters and provide redundancy. Additionally or alternatively, two or more of the multiple fibers may have independently selected optical parameters. In various implementations. the independently selected optical parameters may serve as additional coding symbols that together identify a single article characteristic. Additionally or alternatively, the independently selected optical parameters may serve as identifiers for different article characteristics. FIG. 9 shows an example textile 900 with multiple different fibers 901, 902, 903 interwoven. The multiple different fibers 901, 902, 903 may be used to increase information density, e.g., by selecting different optical parameters for two or more the fibers, and/or redundancy, e.g., by selecting the same parameters for two or more of the fibers.

In some implementations, the orientation of the article may be unknown prior to scanning and/or untracked/unknown during scanning. Unknown orientation may create ambiguity with regard to identifier fiber read order. For example, if fibers in a garment are characterized from right to left with respect to article flow on a conveyor system, inverting an article may invert the read order of the fibers. Other orientations may generate other read orders.

In some cases, direction markings 188 such as arrows, chevrons, or other directional indica, may be used to indicate an article orientation for fiber read order. In some cases, the multiple fibers may be read-order independent. For example, possible permutations of the different optical parameters may be assigned to the same characteristic. In some cases, a read order may be implied. For example, optical parameters may be interpreted from largest to smallest value. In some cases, a read order may be signaled expressly using the optical parameters. For example, start/end codes may be signaled using specific optical parameters, e.g., to indicate that a group of proximate parallel fibers should be read from one side of the group to the other. In some cases, a specific type of optical parameter may signal read order while another type may provide symbols to indicate characteristic identity. For example, widths of bands in an optical response may be used a parameter to indicate read order, while the position of those same bands may indicate the parameter values that identify the characteristic. As an illustrative example, the band position values may be sent in order from widest to narrowest band to indicate the particular characteristic of the article. In other words, in the illustrative example, only the position values of the bands makeup the identifier while the widths of the bands indicate the order in which the position values are included in the identifier. Other combinations of optical parameter value types may be used to signal read order and identifier symbols.

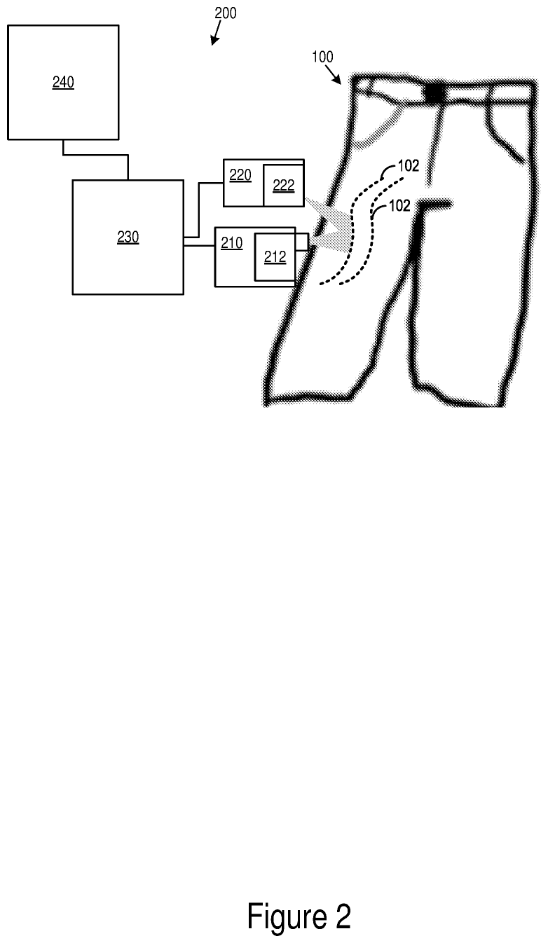

Referring now to FIG. 2 an example fiber read system (FRS) 200 is shown. The example FRS 200 may include an illuminator 210, which may include output optics 212; an optical sensor 220, which may include input optics 222, scanning circuitry 230 to control scans over optical parameter value space, and processing circuitry 240 to process optical parameter values and/or generate query requests.

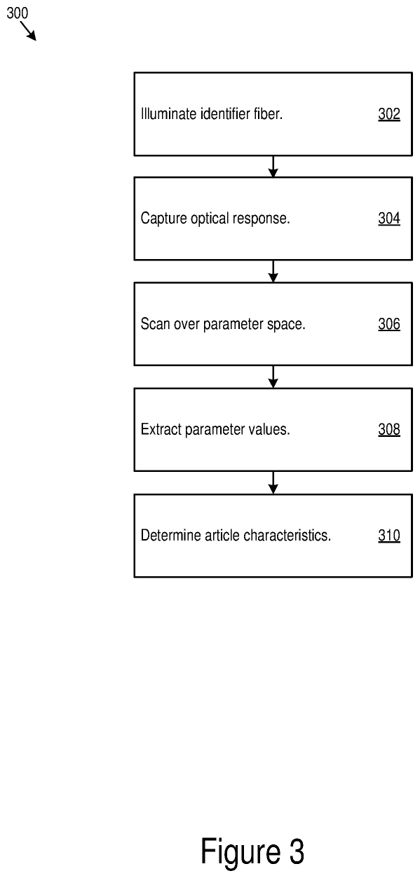

Referring also to FIG. 3, while continuing to refer to FIG. 2, example fiber read logic (FRL) 300 is shown. In various implementations, the FRL 300 may be executed on the circuitry of the FRS 200. The FRL 300 may cause the illuminator 210 to illuminate the one or more identifier fibers 102 on the example article 100 (302).

In various implementations, the illuminator 210 may include various illumination sources. For example, the illuminator 210 may be a light emitting diode (LED) source and/or a laser light source. The illuminator 210 may be a broadband source, such as an ultrafast pulse laser, a continuum and/or super-continuum source, a white light source, or source with an output broader than the bands of the optical response being characterized. The illuminator may be a narrowband source, such as a low noise continuous wave laser, a tungsten lamp, a tunable frequency output laser, narrowband LED, or other source with output bands narrower than the band of the optical response being characterized. The illuminator 210 may be a coherent or non-coherent light source. The illuminator 210 may include an infrared and/or near-infrared light source. The illuminator may include virtually any light source, with output capable of producing at least a portion of the optical response being characterized.

The illuminator 210 may further include output optics. The output optics may include various output optics the direct the output light from the illuminator on to the article and/or scan the output of the illuminator over a parameter-space of the optical parameters being extracted from the identifier fibers. For example, the output optics 212 may include optics to support fiber (or other waveguide) coupling of the illuminator 210 output. The fiber-coupled output may then be directed onto the article 100 (e.g., by positioning an output of the fiber). The output optics 212 may include free space optics (e.g., such as mirrors, lenses, or other optics) to direct the output light of the illuminator onto the article 100. For example, the output optics 212 may include a tunable filter (e.g., for a broadband illuminator) that may be scanned over the parameter space of the optical parameter values. In some case, e.g., where the illuminator 210 includes a tunable source, the illuminator itself may be scanned, e.g., in addition to or in lieu of an output filter.

The illuminator 210 output may be incident on the identifier fiber 102 and generate an optical response 180. The FRL 300 may cause the optical sensor to capture the optical response 180 (304).

The optical sensor 220 may include various sensor types. Such as pixel array sensors, photodiodes, or various other sensor configurations. The optical sensor 220 may include silicon (or other II-VI) semiconductor sensors, indium-gallium-arsenide (or other III-V) semiconductor sensors, germanium sensors, mercury-cadmium-telluride, and/or various other optical sensor types. The optical sensor 220 may have sensitivity in the infrared and/or NIR spectrum.

The optical sensor may include input optics 222, which may direct the optical response onto the optical sensor (e.g., using free-space and/or fiber-coupled schemes). The input optics 222 may further support scanning across the parameter space of the optical parameter values. For example, the input optics 222 may include a frequency filter (and/or grating or other frequency discriminating optics) to perform a scan over a frequency/wavelength parameter space. Other scanning optics may be used.

The FRL 300 may (e.g., via scanning circuitry 230) cause a scan over the parameter space of the optical parameter values being characterized (306). In some cases, multiple scans may be used to scan for different parameter types. However, in some cases, multiple different parameter types may gleaned in a single scan. For example, a frequency scan may cover the parameter spaces for band center position, the width of bands, and peak-to-peak spacing of bands. In an illustrative example, the FRL 300 may effect a scan over at least a portion of the infrared spectrum to support Fourier-transform infrared (FTIR) spectroscopy to capture the optical response.

The FRL 300 may extract, (e.g., using processing circuitry 240) optical parameter values 182, 184, 186 from the captured optical response 180 (308). After extraction of the optical parameters, the FRL 300 may reference the optical parameter values 182, 184, 186 against a database to determine the corresponding characteristics of the example article 100 (310). The database (discussed in more detail below) may be local to the FRS 200 or remotely disposed. In some cases, the reference may be performed by providing a query to a third-party database in system. Nevertheless, for locally disposed parameter databases, query may be locally handled by the processing circuitry 240 of the FRS 200.

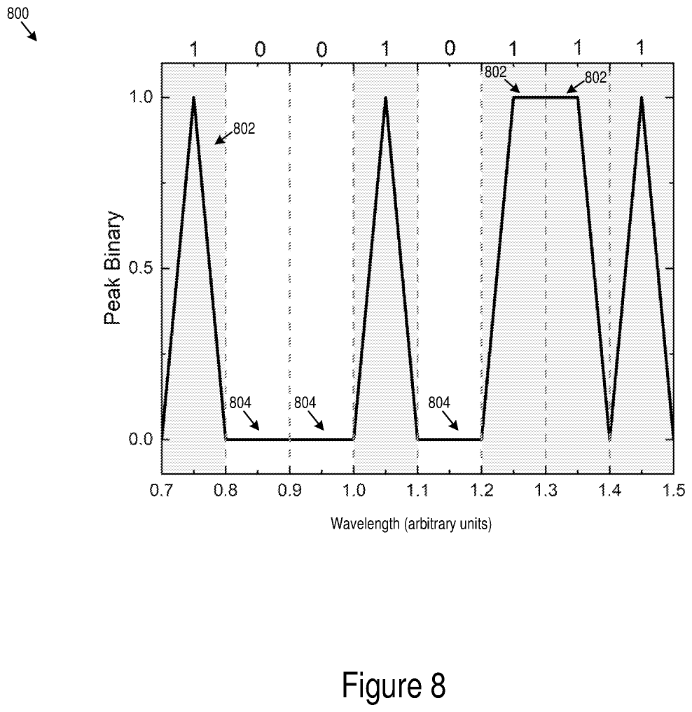

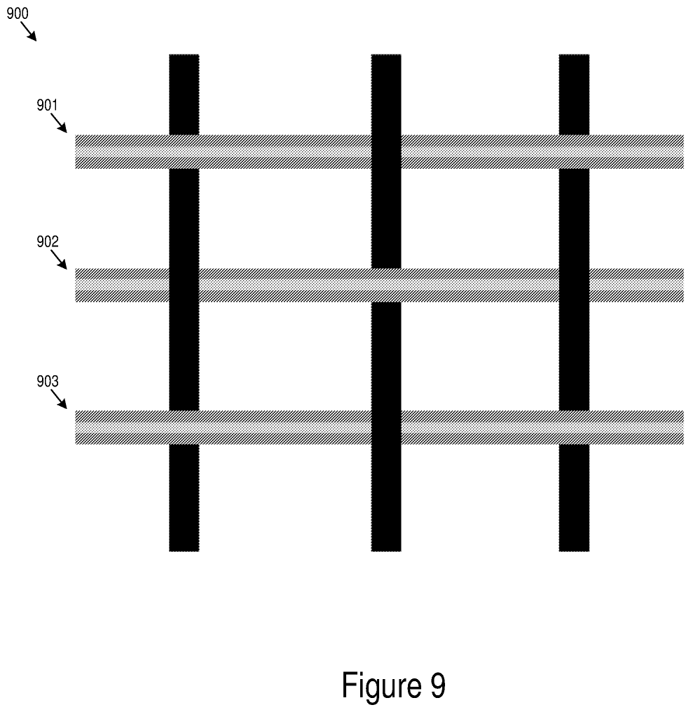

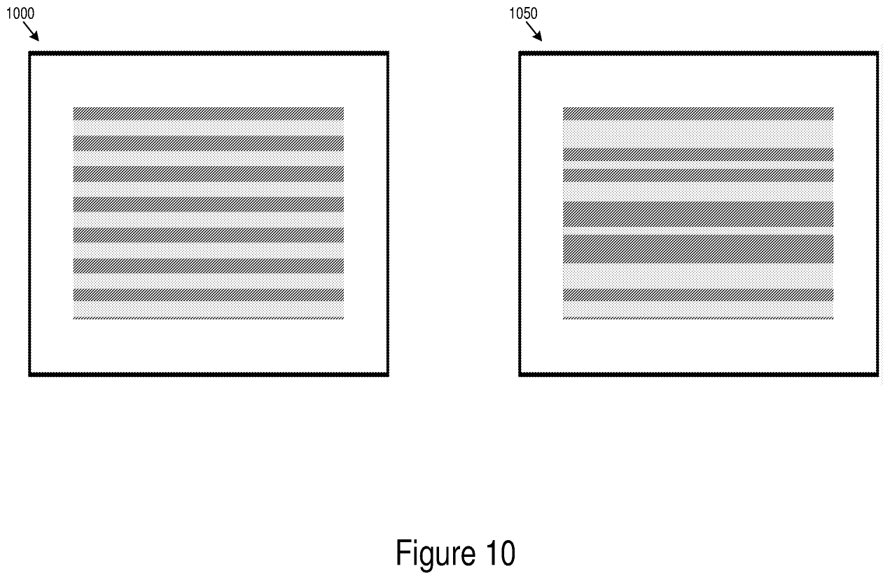

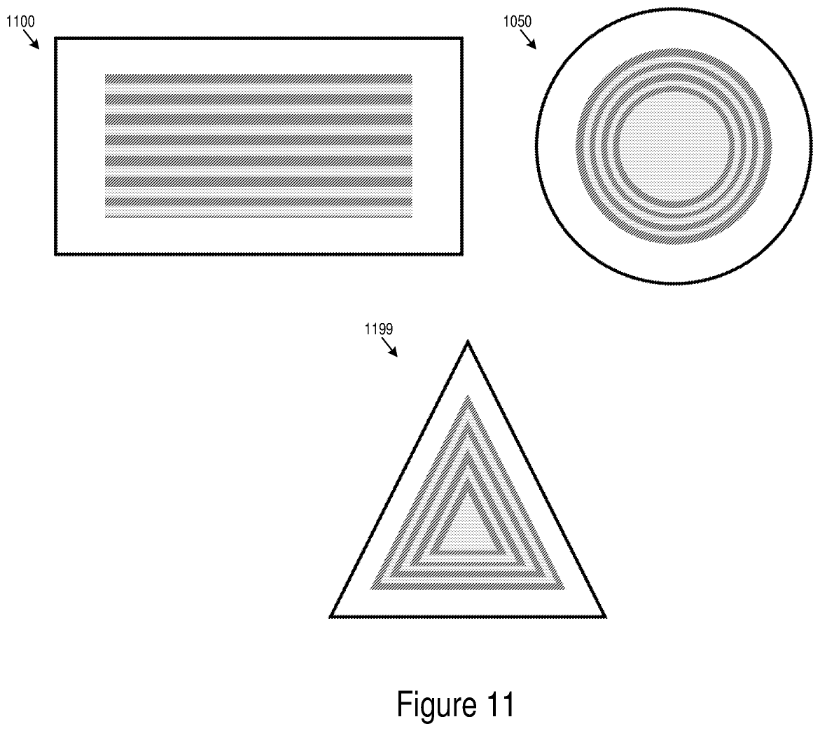

In some cases, the optical parameter value “symbols” may directly specify bits or other information. For example, the symbols may have a specific coding scheme allow information (including information other than lookup information) to be encoded directly into the optical parameter. Accordingly, rather than performing a lookup, the FRS may determine the article characteristic through direct interpretation of the symbols under the coding scheme. For example, one or more identifier fibers may have a particular set of reflectivity peaks and/or valleys at defined positions signaling “1” and/or “0” or other sets of bits. FIG. 8 shows an example coding scheme 800 where peaks 802 and valleys 804 in a may be used to signal “1” and/or “0” bits.

Unicode characters or other character set may be represented by the symbols. The optical parameters may be used as symbols to directly represent elements from virtually any set.

Accordingly, strings and/or other information may be directly encoded into the identifier fibers without reliance on database lookup. For example, care instructions or textile content information (or other tag) information may be directly written into the textile through inclusion of identifier fibers.

The FRS 200 may be implemented in various platforms. For example, the FRS 200 may be implemented on a mobile device, such as a smartphone. For example, the illuminator 210 may be implemented as an LED with a filter attachment. The optical sensor 220 may be implemented by the lighting sensor and or camera sensor of the mobile device. In some cases, laser ranging sources and sensors (e.g., for facial recognition and/or other applications) disposed on mobile devices may be used as the illuminator 210 and optical sensor 220, respectively. In some cases, an add-on module including the illuminator 210, optical sensor 220, scanning circuitry 230, and/or processing circuitry 240 may be mounted on the mobile device for use as the FRS 200.

In some implementations, the FRS 200 may be implemented in an industrial sorting environment (e.g., proximate to an article conveyor system). The illuminator 210 and optical sensor 220 may be positioned to illuminate articles and capture optical responses as the articles pass by on the conveyor system.

In some implementations, the article conveyor system may be used to, at least in part, effect the scan over the parameter space. For example, the conveyor system may be used to position the article to support a scan of incident illumination angles. In some cases, the conveyor system may orient articles in according with orientation indica to facilitate fiber reads of multiple identifier fibers in a specified read order. In some cases, after reading fibers and discerning a read order specified by the fibers, the conveyor system may reorient the article in accord with the determined read order to orient the example article 100 for downstream processing, such as packaging, cutting, assembly, and/or other downstream processing.

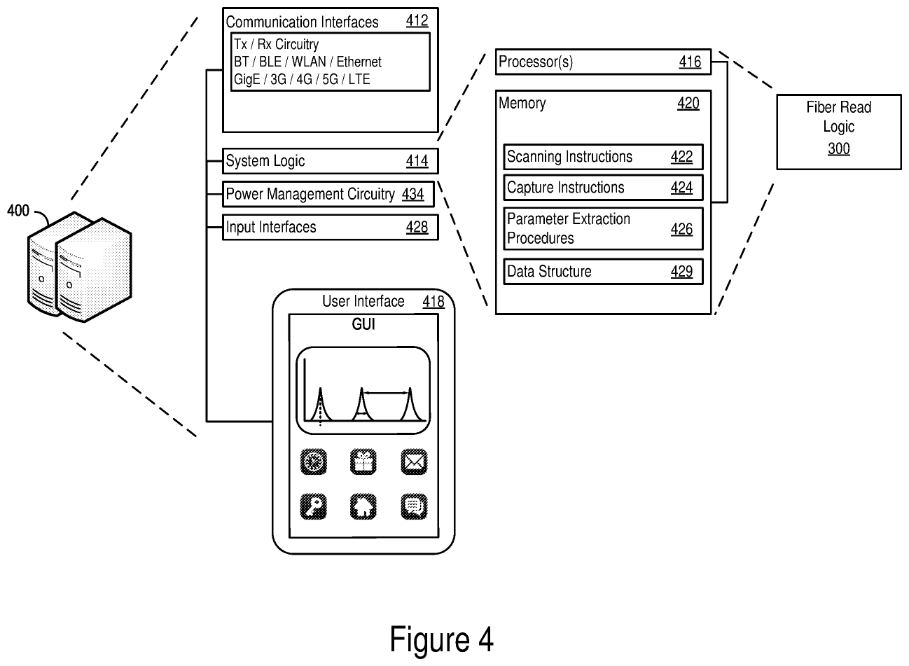

FIG. 4 shows an example fiber read execution environment (FREE) 400, which, for example, may operate as scanning circuitry 230 and/or processing circuitry 240. The FREE 400 may include system logic 414 to support coordination illumination by the illuminator 210 and capture by the optical sensor 220. The system logic 414 may include processors 416, memory 420, and/or other circuitry, which may be used to analyze the optical response and extract parameter values. In various implementations where a locally-controlled parameter database is used, the system logic 414 may support optical parameter lookup by executing a query using the extracted parameters.

The memory 420 may be used to store: scanning instructions 422, capture instructions 424, and/or parameter extraction procedures 426 used in execution of the fiber reads. In various implementations supporting internal lookup functionality, the memory 420 may include a parameter data structure 429 relating parameter values to article characteristics.

The FREE 400 may also include one or more communication interfaces 412, which may support wireless, e.g. Bluetooth, Bluetooth Low Energy, Wi-Fi, WLAN, cellular (3G, 4G, 5G, LTE/A), and/or wired, ethernet, Gigabit ethernet, optical networking protocols. The FREE 400 may include power management circuitry 434 and one or more input interfaces 428.

The FREE 400 may also include a user interface 418 that may include man-machine interfaces and/or graphical user interfaces (GUI). The GUI may be used to present options for scanning, parameter extraction, article management, and/or other operations.

The FREE 400 may be implemented as a localized system, in some implementations. In some implementations, the FREE 400 may be implemented as a distributed system. For example, the FREE 400 may be deployed in a cloud computing environment. In some cases, the FREE 400 may be implemented (at least in part) on hardware integrated (and/or co-located) with the illuminator 210 and/or the optical sensor 220. Accordingly, the illuminator 210 and optical sensor 220 may be controlled via localized processing hardware and/or remote/distributed hardware systems.

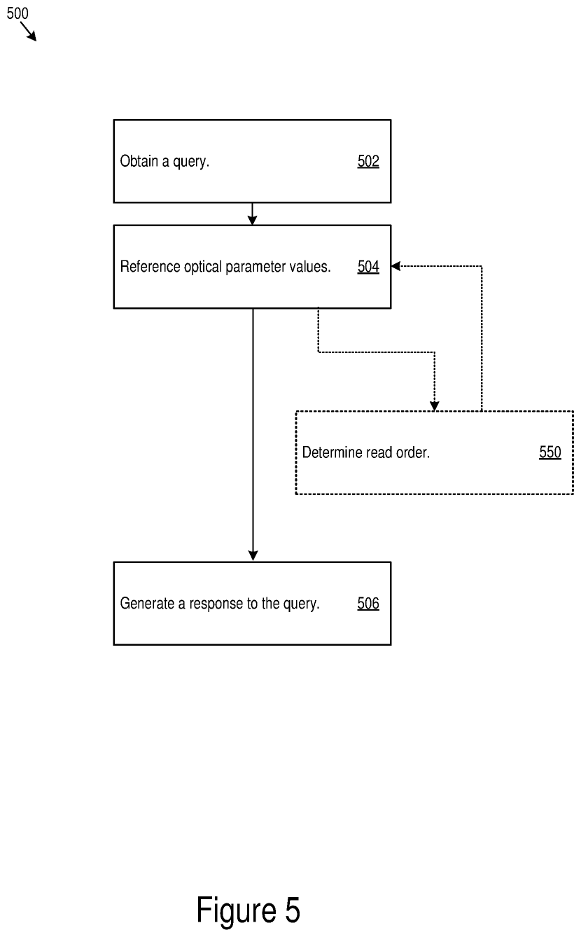

FIG. 5 shows example fiber lookup logic (FLL) 500. The example FLL 500 may be implemented on circuitry, for example on processing circuitry 230 when executed as part of the FRS 200. However, in various implementations the FLL 500 may be implemented separately from the FRS 200, for example as a third-party look-up service.

The FLL 500 may obtain a query including a measured optical parameter value, the measured optical parameter value measured from an optical response of an identifier fiber embedded in an article (502). For example, the FLL 500 may receive a query from a remote FRS (e.g., the FRS 200) that measured the optical response of an article. In an example, the FLL 500 obtains a query based on an internal optical response capture.

The FLL 500 may reference the measured optical parameter value against a data structure to determine a corresponding characteristic of the article (504). The data structure may relate optical parameter values to article characteristics, e.g., via a table or other reference lookup structure. In some implementations, the FLL 500 may support lookups based on multiple parameters.

In read order dependent lookups, the FLL 500, may determine a read order (550). In some cases, determining the read order may include extracting an express read order encoded in the parameter values, (e.g., via a specific parameter type used to convey read order, a start or end parameter or sequence of parameter, or other expressly encoded read order). In some cases, determining the read order may include obtaining a read order indicated in the query (and/or applying the parameter in the specific order in which the parameters are included in the query). In some cases, determining the read order may include determining an implied order. For example, parameters may have a default order, such ordering from smallest value to largest value (or vice versa)—or other intrinsic ordering.

After determining the article characteristic, the FLL 500 may generate a response to the query indicating the characteristic (506). In some cases, where article orientation correction information may be gleaned from read-order data, the response may further include an indication of an orientation correction for the article, e.g., to support downstream processing of the article.

By determining read order for fiber, the FLL 500 provides a technical solution to the technical problem of receiving a query in which a fiber read system reads fibers and or report parameter value in an arbitrary order due to random article position, non-uniform parameter extraction procedures, and/or other conditions affecting the reported order of parameters in a query. Thus, the FLL 500 improves the operation of the underlying hardware by increasing accuracy and/or allowing reuse of parameter permutations (e.g., increasing the number of characteristics that may be represented by a given set of parameters) resulting in better system flexibility and efficiency.

By determining read order and/or providing corrective orientation instructions for article downstream processing, provides a technical solution to the technical problem of incorrect article orientation on conveyor systems. The FLL 500 therefore improves the operation of the conveyer system by ensuring accurate article orientation.

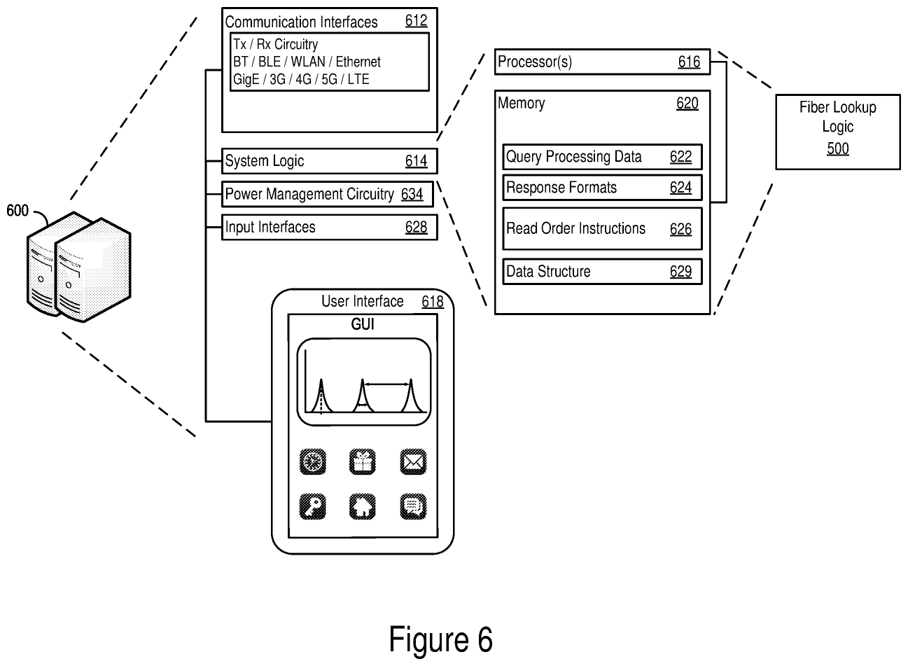

FIG. 6 shows an example fiber lookup execution environment (FLEE) 600. The FLEE 600 may include system logic 614 to support query processing and response. The system logic 614 may include processors 616, memory 620, and/or other circuitry, which may be used to execute lookups and/or process read order data.

The memory 620 may be used to store: query processing data 422, response formats 624, and/or read order instructions 626 used in execution of the queries. The memory 620 may include a parameter data structure 629 relating parameter values to article characteristics.

The FLEE 600 may also include one or more communication interfaces 612, which may support wireless, e.g. Bluetooth, Bluetooth Low Energy, Wi-Fi, WLAN, cellular (3G, 4G, 5G, LTE/A), and/or wired, ethernet, Gigabit ethernet, optical networking protocols. The FLEE 600 may include power management circuitry 634 and one or more input interfaces 628.

The FLEE 600 may also include a user interface 618 that may include man-machine interfaces and/or graphical user interfaces (GUI). The GUI may be used to present options for query response, read-order options, and/or other operations.

The FLEE 600 may be implemented as a localized system, in some implementations. In some implementations, the FLEE 600 may be implemented as a distributed system. For example, the FLEE 600 may be deployed in a cloud computing environment. In some cases, the FLEE 600 may be implemented (at least in part) on hardware integrated (and/or co-located) with the illuminator 210 and/or the optical sensor 220. Accordingly, the query response handling may occur on local or remote hardware, which may be maintained internally or via third party handling.

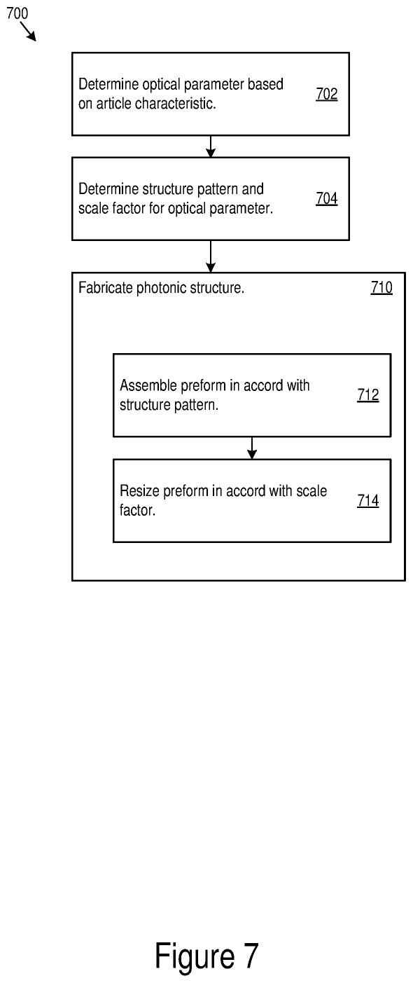

FIG. 7 shows an example method 700 for manufacture of an identifier fiber. The identifier fiber may be used to signal one or more optical parameters associated with one or more characteristics of an article. Accordingly, based on the selected characteristic(s) of the article, the optical parameters for the corresponding identifier fiber may be determined (702). For example, a reverse lookup may be performed. A characteristic may be referenced against the data structures discussed above (e.g., using a reverse query including a characteristic rather than an optical parameter) to determine corresponding optical parameters.

Once the optical parameter is determined, a structure pattern and scale factor may be determined (704). The structure pattern may include a preform-scale version of the photonic structure of the identifier fiber. The scale factor may include a factor that transforms the length scales of the preform into those of the photonic structure.

Making the photonic structure (710) includes assembling the preform in accord with the structure pattern (712) and then resizing the preform (e.g., through the application of force and/or heat) in accordance with the scale factor (714).

Assembling preform may include various preform assembly methods. For example, the preform may be assembled by stacking component materials of the preform in accord with the structure pattern. The stacked component materials may be heated to adhere layers, rods, or other stacked component materials. The stack may include multiple flat layers in a “sandwich” type configuration. The layers may have uniform thickness or non-uniform thickness. For example, FIG. 10 shows two example fiber cross sections 1000, 1050. The first of the two example cross sections includes a periodic cross section 1000 with uniform layer thickness. The second of the two cross sections includes a periodic cross section 1050 with non-uniform layer thickness. The layer may repeat in material/thickness or use a non-repeating pattern. The stack may include parallel round/hexagonal/square/triangular rods to generate a desired cross section, such as cross sections with multiple concentric layers, air gaps, checker patterns, or other cross-sectional patterns. In some cases, a “sandwich” type stack may be rolled to generate a cross section with multiple concentric layers. For example, FIG. 11 shows three example fiber cross sections 1100, 1150, 1199. The first of the three example cross sections includes an example rectangular cross section 1100. The second of the three example cross sections includes an example circular cross section 1150. The third of the three example cross sections includes an example triangular cross section 1199.

In an example, the preform may be assembled by growing the preform layer-by-layer using vapor, thermal, sputter, and/or spray deposition techniques. Masking and/or etching may be used to create patterns in the various layers. The deposition may be performed while rolling the preform to allow for the creation of multiple concentric layers.

Various other flexible fabrication techniques may be used such as sol-gel fabrication and/or three-dimensional printing.

Resizing in accord with the scale factor may include various resizing techniques including pressing, drawing, cutting, and/or extruding. For example, a preform may be pressed in one or more dimensions in accordance with the scale factor. A sheet from a pressed stack may be cut into fibers, extruded through a grate. Pressing in two dimensions may produce a fiber. Heat may be applied to soften the material during resizing to avoid breakage during application of force.

In various implementations, the preform may be drawn. The preform may be fed into a furnace at a feed speed and pulled from the furnace at a pull speed. The ratio of pull speed to feed speed may be proportionate to the ratio of input cross sectional area to the output cross sectional area. Thus, lengths may scale with the square root of this ratio. Accordingly, the square of the scale factor may be proportionate to the ratio pull speed to feed speed.

The furnace may provide heating during the drawing process. The heat may be selected to be above a softening temperature of the preform materials. Softening the materials may prevent levels of tension that result in material breakage during drawing. In some cases, the heat may be selected to be below a melting temperature of the preform material. Melting may cause the materials to run in a liquid state and deform the structure pattern rather than scaling the pattern. Further, melting may cause the materials to stretch freely under tension and prevent control of feed/pull speed ratios. In some cases, the heat may be selected to be targeted at just above that needed to prevent breakage due to tension. In some cases, lower temperature drawing may be comparatively better for scaling without deformation than higher temperature drawing.

Additionally or alternatively, identifier fibers may be created through extrusion. For example, fibers extruded through spinnerets (and/or other extrusion chucks) that can create the multi-layered structures at the scale of the photonic structures (e.g., without a preform). For example, extrusion may be used to create a preform, and the preform may then be drawn or extruded in a second stage of extrusion.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be embodied as a signal and/or data stream and/or may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may particularly include a storage medium and instructions stored in or on the medium, and the instructions when executed by the circuitry in a device may cause the device to implement any of the processing described above or illustrated in the drawings.

The implementations may be distributed as circuitry, e.g., hardware, and/or a combination of hardware and software among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

### EXAMPLE IMPLEMENTATIONS

Various illustrative example implementations are included. The illustrative example implementations are illustrative of the general architectures and techniques described above and in the claims below. Designations of particular features such as “key”, “critical”, “important”, “must”, and/or other similar designations are included to clarify the relationship of that particular feature to the specific illustrative scenario/scenarios in which the particular feature is discussed. Such a relationship to the same degree may not apply without express description of such a relationship to other implementations. Nevertheless, the various features described with respect to the individual example implementations may be readily and optionally integrated with other implementations with or without various other features present in the respective example implementation.

For a set combination of refractive indexes of the two polymers inside a fiber, it is possible to alter the photonic response by changing the thickness of the layers via the rate at which the fiber is pulled. Generally, higher draw speeds result in increased draw down ratios (DDR), or the geometric ratio of features in the final fiber as compared to the original preform. Increased DDRs result in thinner layers, blue-shifting the fundamental photonic response of the fiber. Typically, a 1DPC is designed for a photonic peak response at a single fundamental wavelength, but in this work the aim is to utilize a combination of the fundamental resonance with multiple overtone peaks, creating a barcode “fingerprint”. Parasitic absorption in the mid- and long-wave infrared (5.5-13.5 μm) may reduce signal strength.

Designing for multiple overtone peaks in the 1.5-5.5 μm regime, where the extinction coefficient is less than 10⁻³, allows for a higher degree of reflectance. This is compared to peak extinction coefficient values of greater than 0.6 in the mid-IR. The fundamental and overtone peaks discussed here are in relation to the peaks created by constructive and destructive interference induced by the refractive index contrast between layers, which is approximately 0.1, depending on wavelength. Resultant interference spectra can therefore be engineered and modified to encode desired information, not limited to only the material composition.

When the optical thickness (n_{λ}*layer thickness) of both materials are nearly equal the even order overtones destructively interfere. Given the relatively close refractive index of the two polymers, and similar layer thicknesses, there are certain draw conditions, mainly when the lower index PMMA layers are thicker than the PC layers, where this destructive interference could occur and is demonstrated by the odd overtones. When the material layer thicknesses shift away from the optical thickness, as in the simulated and experimental data from a drawn fiber, both even and odd overtones are apparent. Factors that determine the spectral signature include layer thickness and refractive index contrast, as previously mentioned, as well as the number of layers in the photonic crystal. Increasing the number of layers results in a decrease of the peak FWHM as well as an increase in the peak reflectance. This narrowing effect applies to both the fundamental peaks as well as the overtones.

The fiber draw process may have fluctuations that result in variations in the final fiber geometry, thus affecting the photonic response of the fiber. For transfer matrix simulations when quantifying the photonic response as a result of fluctuations above and below a target thickness, there is a linear relationship between peak wavelength and the layer thickness of the photonic crystal; a 5% shift in layer thickness results in a 5% shift in the peak wavelength. Furthermore, the ratio of FWHM at a certain thickness variation to the central FWHM decreases with increasing variation. This holds until the point that particular peak (whether fundamental or overtone) shifts to the next resonance order position. Finally, the FWHM of an overtone peak is narrower than that of a fundamental peak, depending on the number (e.g., λ/2, λ/5, etc) of the overtone, with FWHM decreasing for higher order overtones. In a realistic scenario, a wide variety of signatures may be used to convey information about different brands and products, as well as coding for fiber composition and property information for recycling, such as intrinsic viscosity. The number of layers is also a discrete parameter with anywhere from 50 to 100 layers providing required reflectance intensity and narrow FWHM for measurement. Finally, layer thicknesses can be continuously tuned by adjusting the draw and feed rate. This results in a potential of thousands of possible combinations and does not include variations such as switching the sequence of material layers (such as from n_{L} to n_{H} or n_{H} to n_{L}), thus pointing to utilization of these photonic signatures as unique product identifiers.

During the draw process, the volume of preform material entering the furnace and volume of fiber material pulled from the cone within the furnace stays constant, due to conservation of mass. Thus, as the draw speed is increased, the cross-section of the fiber decreases. The DDR defines this volume conservation as the macroscale preform is drawn to a microscale fiber, given by Equation 1:

$$DDR = \sqrt{\frac{\dot{D}}{\dot{F}}} \qquad ( 1 )$$

Where \dot{D} is the draw rate of the fiber out of the cone and \dot{F} is the feed rate of the preform into the furnace, both in meters per minute. For various illustrative example preforms, when the fiber is drawn at rates ranging from 3 to 9.3 m min⁻¹, it was possible to achieve DDRs of 30-130. Original film thicknesses of 75 μm and 125 μm shrunk to approximately 0.75 μm to 1.25 μm, respectively, in the final fiber at a DDR of 100. Smaller overall layer thickness reduces the number of possible states where constructive interference can occur at a particular wavelength, and thus the number of peaks for the given regime (e.g., 1.5-5.5 μm) decreases as well. The colored traces on each plot correspond to transfer matrix simulations which take the average (green), maximum standard deviation (red), and minimum standard deviation (blue) of the PC and PMMA layer thicknesses as inputs, including PC cladding thickness.

Even minor changes in layer thickness can result in a shift in the interference patterns, as previously discussed. The variation in layer thicknesses also helps explain the broad experimental peaks noted in several samples. This is most apparent in the sample drawn at 4.5 m min⁻¹ where the peak at 5.1 μm is best fitted by a combination of the three simulations. There are also certain peaks that appear in the experimental data but are not predicted by simulation, such as the peak at 2.7 μm for the 5.5 m min⁻¹ fiber. This may be partially due to absorption in the PC cladding; simulations show peak intensity increases with a reduction in cladding thickness. In an industrial environment, if a certain barcode response is to be achieved and maintained, the DDR based on draw rate and feed rate is a useful control parameter. The fiber draw tower utilized in this study has in-situ infrared measurement capability. Peak shift to shorter wavelengths at higher draw rates, and thus thinner layers, is demonstrated and is correlated to the DDR. Note the “dark” region at ˜3.4 μm, due to increased molecular absorption at this wavelength in both the PC and PMMA.

An illustrative example proof-of-concept fiber was created that had twice the number of layers (101 layers) that were individually thinner (75 vs 125 μm) in the preform. Generally, increasing the number of layers in a 1DPC increases reflectance intensity for a fixed refractive index contrast. The peak reflectance depending on the number of layer pairs (N) is approximately given by Equation 2:

$$R ≅ {( \frac{{{n}_{0} ( {n}_{H} )}^{2 N} - {{n}_{s} ( {n}_{L} )}^{2 N}}{{{n}_{0} ( {n}_{H} )}^{2 N} - {{n}_{s} ( {n}_{L} )}^{2 N}} )}^{2} \qquad ( 2 )$$

Where n₀ is the refractive index of air and n_{S} is the refractive index of the substrate. Since measurements are made with a polycarbonate cladding as a backing to the photonic crystal insert within the fiber, the same refractive index is used for n_{H} and n_{S}. Furthermore, the minimum FWHM for the layer pair of PC and PMMA is approximately given by Equation 3:

$$FWHM ≅ \frac{4 {λ}_{0}}{π} asin ( \frac{{n}_{H} - {n}_{L}}{{n}_{H} + {n}_{L}} ) \qquad ( 3 )$$

Using thinner layers in the preform resulted in sub-micrometer layer thicknesses in the drawn fiber, exhibiting fundamental reflectance peaks in the 1.5-5.5 μm regime at DDRs of 92, 110, and 126. In-situ photonic data shows similar behavior to the 53-layer fiber, in that higher DDRs (e.g., more and thinner layers) resulted in a blue shift.

The peak reflectance intensity, measured via μ-FTIR, of the 53-layer fiber drawn at 7.5 m min⁻¹ was 19% while the 101-layer fiber drawn at 5.0 m min⁻¹ was 51%, demonstrating how an increased number of layers increases reflectance. In addition to providing higher reflectance intensity, an increase in layers also increases the sharpness of the peaks, measured by their FWHM. The 53-layer fiber drawn at 7.5 m min⁻¹ and the 101-layer fiber drawn at 5.0 m min⁻¹ are compared due to their similar layer thicknesses and overtone peak locations. The FWHM of the first overtone (λ/2) for the 53-layer fiber is 170 nm while the 101-layer fiber is 139 nm. However, the second overtone (λ/3) for the 53-layer fiber is lower (75 nm) than the 101-layer fiber (103 nm). The simulated FWHM for the second overtone for the 53-layer fiber is 12.6 nm while for the 101-layer fiber it is 14.4 nm, similar to what was seen experimentally. While the experimental peak FWHM is nearly an order of magnitude larger, likely due to imperfections induced during the manufacturing process, the simulated FWHM helps predict trends depending on the number of layers.

Note that the reflectance response in a 1DPC typically depends on the angle of incidence (AOI) of the probe beam. Snell's Law (Equation 4),

$$sin {θ}_{i} = {n}_{L} sin {θ}_{L} = {n}_{H} sin {θ}_{H} \qquad ( 4 )$$

where θᵢ is the angle of incidence of light (assuming coming from air where n˜1), can be modified to calculate the peak response wavelength of a 1DPC with angle of incidence:

$${λ}_{C} = {λ}_{0} [ {( 1 - {sin}^{2} {θ}_{i} / {n}_{L}^{2} )}^{\frac{1}{2}} + {( 1 - {sin}^{2} {θ}_{i} / {n}_{H}^{2} )}^{\frac{1}{2}} ] \qquad ( 5 )$$

Where λ_{C} is the center wavelength at that angle while λ₀ is the center wavelength at normal incidence (0°). The theoretical prediction matches well with the simulations showing the predicted response of two different fibers that have a single peak in the 3-5 μm range (101-layer fiber at 9.0 m min⁻¹) as well as multiple peaks in the 1.5-5 μm range (53-layer fiber at 5.5 m min⁻¹). Experimental spectra collected at 10°, 12-24°, 30°, 40°, 50°, 60°, and 70° angles of incidence to the fiber show good agreement with the simulated predictions, allowing to compensate for the angle-dependent shift. The intensity of reflected light decreases at higher angles of incidence, and thus may degrade signal-to-noise ratio. However, a benefit of having multiple overtone reflectance peaks is that the wavelength location of the peaks will shift at the same rate, and thus the wavelength difference between two overtone peaks can also be utilized as an angle-independent identification marker. Furthermore, implementing a circular cross section design for the photonic crystal layers could further reduce the angle dependence of the response as light striking the fiber would always be normal to the photonic layer stack, depending on the size of the optical scanning area.

The cost of detection is related to which photodetection mechanism is used. The most widely used materials in industrial FTIR sensors are semiconductor alloys of mercury cadmium telluride (MCT or HgCdTe), which has high quantum efficiency (QE) from the near to far infrared. MCT detectors may use cryogenic cooling (typically liquid nitrogen). Moving to the near infrared (0.75-1.65 μm), there are a wider array of materials that have good QE with the most common being indium gallium arsenide (InGaAs). InGaAs detectors have the benefit of only needing thermoelectric cooling without the need for liquid nitrogen. Shifting to even shorter wavelengths, the majority of cameras in commercial applications use silicon (Si) detectors, with high sensitivity in the range 0.35-1.1 μm, no cooling requirements, and wide availability and very low cost. The example fibers exhibit multiple spectral peaks present across this entire wavelength range. Therefore, the barcode signature can be detected even using lower cost spectrometers integrated into a smartphone. The overlap of engineered reflectance spectra with pigments and dyes in colored fabrics may present a challenge. However, this challenge can be mitigated by increasing reflectance intensity of more layers or targeting the near infrared detection window (0.75-1.0 μm) of silicon.

Another consideration for the overall measurement system is the availability of cost-effective light sources for interrogation of the textiles. While the exact details of the lamps and spectrometers utilized in commercial automated sorting systems are proprietary, some assumptions can be made. For example, handheld systems will most likely utilize either a visible or NIR light emitting diode or a tungsten-halogen bulb. Larger, automated systems likely utilize larger tungsten lamps or potentially laser illuminators. Generally, the light sources are cheaper than the spectrometers, but if longer wavelengths (e.g., >2 μm) are needed for measurement, the cost of light sources increases compared to visible wavelengths.

Weaving the photonic fibers into a background fabric was performed. In an example system, the fiber is effectively transparent in the visible regime which lends itself to being an aesthetically neutral addition to a garment. The identification system associates the spectral peak characteristics with a database that contains previously recorded spectral signatures that are categorized according to the number of peaks, where the peaks are located, and the peak FWHM.

In an example, a fiber was integrated into the woven fabric, The measured response of the photonic fiber is noticeably apparent over that of the polyethylene (PE) warp yarns. The ability to differentiate the photonic fiber from the background textile was explored using short-wave infrared (SWIR) imaging with response from 1-5 μm. As a comparison, a nylon fiber was added as a weft yarn and woven next to the photonic fiber. A photonic filter is chosen with the same spectral window where the fiber is expected to have a reflectance peak, here with a peak at 3.5 μm. The photonic fiber is clearly visible in yellow while the nylon fiber does not appear in sharp contrast. The fibers with higher DDR (generally >80) were more easily woven into fabrics due to similar cross-sectional dimensions to the other warp and weft yarns.

Photonic crystal fiber preforms were fabricated by placing a multilayer stack of polymethyl methacrylate (PMMA, n˜1.5) and polycarbonate (PC, n˜1.6) films into the center of a milled PC bar and then covered with an additional PC bar to protect the photonic crystal insert. The films had thicknesses of either 75 μm (3 mil) or 125 μm (5 mil). The preforms were typically 300-350 mm in length with a 16 mm by 26 mm cross section. Preforms were consolidated using a hydraulic press at 200 kg of force and a top and bottom platen temperature of 175° C. A custom draw tower with a three-zone furnace was used to heat the preform and initiate the draw process. For all fibers presented in this work, the following zone temperatures were used: top zone set to 150° C., middle zone set to 270° C., and the lower zone set to 110° C. The feed rate of the preform into the furnace was kept constant at 1.5 mm/min. Once the draw process was initiated the drawn cross section size of the fiber was controlled by altering the tractor speed on the tower. Tractor speeds from 3 to 9.3 meters per minute were utilized which resulted in draw down ratios (DDR) of around 30-130 times, with higher speeds resulting in higher draw down ratios. The DDR was calculated as the initial cross section geometry divided by the final cross section geometry.

Multiple spectroscopic systems were utilized for fiber photonic analysis. During the draw process, a customized feeding system was utilized with a FTIR microscope equipped with a 15× reflective objective lens to collect in-situ infrared reflectance measurements. The same microscope was also utilized for collecting static infrared measurements of the fibers. The objective lens has an actual measurement angle that averages between 12-24°. All fibers were measured with the longer axis of the cross section normal to the microscope which oriented the photonic crystal normal to the measurement axis. Angled fiber measurements were made utilizing reflective adapters that were placed in the bench compartment of the FTIR microscope. Multiple fibers were placed parallel to each other to cover the 10 mm aperture of the adapters. Near-infrared spectroscopic measurements were made with a system composed of a broadband light source (0.45-5.5 μm) that was coupled to a Vis/NIR reflectance probe and a NIR spectrometer (0.95-1.65 μm). For visible spectroscopic measurements, the same light source and reflectance probe were utilized but the spectrometer was switched for a spectrometer (0.2-1.1 μm). All infrared measurements were made with reference to a specular gold mirror while the visible measurements were made with reference to a specular aluminum mirror.

Woven samples were fabricated on a rapier loom. As an illustrative example proof-of-concept, photonic fibers were integrated as weft yarns with the warp being composed of either a 370 decitex high density polyethylene yarn with 300 twist/meter “z” twist at 16 ends/cm or 220 decitex polypropylene yarn that has been false twisted. Various weave patterns were also tested. The near infrared fabric analyzed was composed of a 53-layer fiber drawn at 5.0 m/min integrated as a plain weave every fourth pick (16 picks/cm) with the HDPE warp using an 8-harness float. The fabric for short wave infrared imaging was based on a 101-layer fiber drawn at 9.3 m/min and a black nylon filler yarn integrated as a satin weave (also 8-harness float) with every pick (16 picks/cm). Short wave infrared imaging was conducted using a camera (InSb detector) with illumination from a broadband tungsten lamp.

Various implementations have been described. Various other implementations are possible. Table 1 shows various examples.

TABLE 1
Examples

1. An article including:
an identifier fiber embedded in the article; and the identifier fiber; and
a photonic structure within the identifier fiber, the photonic structure having an
optical response selected to identify, at least in part, a characteristic of the
article, where:
optionally, the photonic structure extends along a length of the identifier fiber;
optionally, the article is in accord with and/or used in accord with any article,
textile, device, system and/or method of any of the other examples; and
optionally, the characteristic is indicated through an encoding scheme based on
optical parameters values of an optical response of the photonic structure.
2. The article of example 1 or any of the other examples in this table, where
the article includes a textile, where:
optionally, the identifier fiber is woven into the textile;
optionally, the textile includes a non-woven material (e.g., leather, non-woven
polymer fiber sheets, and/or other non-woven material).
3. The article of example 2 or any of the other examples in this table, where
the identifier fiber is woven among multiple base material fibers of the textile.
4. The article of example 1 or any of the other examples in this table, where
the characteristic of the article includes:
optionally, a base material makeup of the article;
optionally, an identity of the article;
optionally, a maker of an article;
optionally, a textile recycling sorting reference for the article (e.g., an indication of
what recycling category the textiles of the article are assigned to);
optionally, a manufacture date of the article and/or textiles that makeup the article;
optionally, a serial number, a stock keeping unit (SKU), a universal product code,
and/or other identifier string for the article and/or textiles in the article;
optionally, a tracking identifier for logistics (e.g., shipping tracking, manufacture
tracing, supply chain monitoring, and/or other tracking).
5. The article of example 1 or any of the other examples in this table, where
the photonic structure includes a reflector with a selected reflectivity profile (e.g.,
in frequency-space and/or wavelength-space), where:
optionally, the width of a band in the selected reflectivity profile is tuned to effect
selection of the optical response;
optionally, a center position of a band in the selected reflectivity profile is tuned to
effect selection of the optical response;
optionally, a peak-to-peak spacing of overtones in the selected reflectivity profile is
tuned to effect selection of the optical response; and
optionally, an incident-light-angle dependence of the selected reflectivity profile is
tuned to effect selection of the optical response.
6. The article of example 1 or any of the other examples in this table, where
the photonic structure includes a one-dimensional photonic structure running
along an axis of the identifier fiber.
7. The article of example 6 or any of the other examples in this table, where
the photonic structure includes a photonic structure that is radially symmetric
around the axis of the identifier fiber, where:
optionally, a preform used from which the fiber was fabricated was rolled to obtain
the radial symmetry; and
optionally the photonic structure includes a Bragg reflector including multiple layers
concentric about the axis of the identifier fiber, where:
optionally, the multiple concentric layers include a repeating pattern of
polymer layers.
8. The article of example 6 or any of the other examples in this table, where
the photonic structure includes a sandwich-type multilayer structure, where:
optionally, the photonic structure includes a Bragg reflector multiple stacked layers
stretched along the axis of the identifier fiber, where:
optionally, the multiple stacked layers include a repeating pattern of polymer
layers.
9. The article of example 1 or any of the other examples in this table, where
the photonic structure includes a structure includes a selected linear and/or non-
linear optical response to a specific illumination source, where the optical
response is characterized by one or more parameter values that then may be
referenced to a database to identify, at least in part, the characteristic of the
article.
10. The article of example 1 or any of the other examples in this table, where
the photonic structure includes multiple material layers and/or regions with
different materials, where:
optionally, the materials include a polymer material;
optionally, the materials include a glass material, such as silica glass, or
chalcogenide glass;
optionally, the materials include a doped material;
optionally, the materials include a metal material;
optionally, the materials include a birefringent material;
optionally, a plant derived and/or compostable polymer;
optionally, the materials include one or more air gaps; and
optionally, the materials include polycarbonate (PC), polymethyl methacrylate
(PMMA), polystrene (PS), polyethylene terephthalate (PET), poldimethylsiloxane
(PDMS), and/or other polymer materials.
11. The article of example 1 or any of the other examples in this table, where
the optical response is selected to occur at a portion of the optical spectrum
where the article has an absence of optical response features, where:
optionally the optical response is outside of the visible light spectrum.
12. The article of example 1 or any of the other examples in this table, where
the optical response is selected to occur in the infrared spectrum, where:
optionally, the optical response is selected to occur in the near infrared (NIR)
spectrum; and
optionally, the optical response is selected to occur in a detection range of a
silicon-semiconductor-based optical sensor;
optionally, the optical response is selected to occur in a detection range of an
indium-gallium-arsenide-semiconductor-based optical sensor; and
optionally, the optical response is selected to occur in a detection range of a
mercury-cadmium-telluride-based optical sensor.
13. The article of example 1 or any of the other examples in this table, where
the optical response is characterizable via Fourier-transform infrared (FTIR)
spectroscopy.
14. The article of example 1 or any of the other examples in this table, where
the identifier fiber is one of multiple identifier fibers embedded in the article,
where:
optionally, the multiple identifier fibers identify multiple characteristics including the
characteristic;
optionally, the multiple identifier fibers collectively identify the characteristic, where:
optionally, the multiple fibers have different optical responses;
optionally, the two or more of the multiple fibers have the same optical response;
optionally, a read order is indicated via a feature of the multiple identifier fibers or a
feature of the article proximate to one or more of the multiple identifier fibers,
where:
optionally the read order indicated for the multiple fibers indicates an
orientation of downstream processing of the article; and
optionally, the coding of the multiple identifier fibers is read order independent
(e.g., permutations of the group of optical responses of the multiple identifier
fibers are assigned to the same article characteristic).
15. A method including:
illuminating an article including an identifier fiber to cause an optical response from
a photonic structure of the identifier fiber;
capturing the optical response;
determining a parameter value of the optical response dependent on the photonic
structure of the identifier fiber; and
performing a look-up using the parameter value to determine a characteristic of the
article, where:
optionally, the method is in accord with and/or used in accord with any article,
textile, device, system and/or method of any of the other examples in this table.
16. The method of example 15 or any of the other examples in this table, where
illuminating the article includes illuminating the article with an illuminator with an
output where:
optionally, the output is, at least in part, in the infrared spectrum;
optionally, the output has a bandwidth that is wider than that of a band in the
optical response, where:
optionally the bandwidth of the output spans an entire portion of an optical
spectrum in which all optical responses assigned to article characteristics
lie; and
optionally, the output has a bandwidth that is narrower than that of a band in the
optical response, where:
optionally, the method includes scanning the output over a portion of an
optical spectrum in which optical responses assigned to article
characteristics lie.
17. The method of example 15 or any of the other examples in this table, where
capturing the optical response includes scanning an optical filter over a portion of
an optical spectrum in which optical responses assigned to article characteristics
lie.
18. The method of example 15 or any of the other examples in this table, where
illuminating the article includes scanning an illuminator over multiple angles of
light incidence with the article, where:
optionally, the scanning further includes mitigating an angle dependent response
of the photonic structure
optionally, the scanning further includes mapping the angle dependent response of
the photonic structure, where:
optionally, an output has a bandwidth that is narrower than that of a band in
the optical response.
19. The method of example 15 or any of the other examples in this table, where
capturing the optical response includes mapping the optical response versus
frequency and/or wavelength.
20. The method of example 15 or any of the other examples in this table, where
determining a parameter value of the optical response dependent on the
photonic structure includes determining a linear and/or non-linear optical
response:
caused at least in part by the photonic structure; and
that would not be present in the identifier fiber in the absences of a
structural pattern in the photonic structure, even if the material makeup of
the identifier fiber were held constant.
21. The method of example 15 or any of the other examples in this table, where
determining a parameter value of the optical response dependent on the
photonic structure includes:
optionally, determining a reflectivity profile of the photonic structure output over a
portion of an optical spectrum in which optical responses assigned to article
characteristics lie;
optionally, determining a bandwidth of a band present in the optical response;
optionally, determining a center position (e.g., in frequency-space or wavelength-
space) of a band present in the optical response;
optionally, determining a peak-to-peak spacing caused by overtones associated
with the photonic structure;
optionally, determining a layer spacing, pattern spacing, or other structure pattern
of the photonic structure;
optionally, determining a material-to-material refractive index contrast of two or
more materials that makeup the photonic structure; and
optionally, determining a scale factor of the photonic structure.
22. The method of example 15 or any of the other examples in this table, where
capturing the optical response includes performing Fourier-transform infrared
(FTIR) spectroscopy.
23. The method of example 15 or any of the other examples in this table, where
performing the look-up using the parameter value to determine the characteristic
of the article includes referencing the parameter value against a database of
relating parameter values to article characteristics.
24. The method of example 15 or any of the other examples in this table, where
performing the look-up using the parameter value to determine the characteristic
of the article includes performing a lookup of multiple parameter values measure
from multiple identifier fibers in the article, where:
optionally, performing a look-up using the parameter value further includes
performing the lookup using a determined read order for the multiple identifier
fibers in the article; and
optionally, performing a look-up using the parameter value further includes
performing the lookup without regard to read order.
25. A device including:
an illuminator configured to illuminate at least a portion of an article, the portion
including an identifier fiber embedded in the article;
an optical sensor configured to capture an optical response of the identifier fiber;
and
scanning circuitry configured cause the device to perform a scan to determine a
parameter value of the optical response, the parameter value of the optical
response tuned to identify a characteristic of the article, where:
optionally, the device is in accord with and/or used in accord with any
article, textile, device, system and/or method of any of the other examples
in this table.
26. The device of example 26 or any of the other examples in this table, where
the illuminator includes:
optionally, a light emitting diode;
optionally, a laser source;
optionally, a tungsten lamp;
optionally, a broadband coherent light source (e.g., a continuum and/or super-
continuum light source, other broadband light source);
optionally, a narrowband light source (e.g. a continuous wave laser source, a
feedback stabilized light source, or other narrowband and/or low noise light
source)
optionally, an infrared light source;
optionally, a fiber-coupled light source;
optionally, a free-space light source;
optionally, light source mounted on a mobile device (e.g., a smartphone, tablet,
laptop, and/or other mobile device);
optionally, light source mounted on a Fourier-transform infrared (FTIR)
spectroscopy add-on module for a mobile device;
optionally, a light source for an article and/or article sorting scanner, where:
optionally, the sorting scanner light source is paired with a rotating mirror to
generate a multi-angle and/or rotating illumination pattern.
27. The device of example 25 or any of the other examples in this table, where
the optical sensor includes:
optionally, a silicon-semiconductor-based optical sensor;
optionally, an indium-gallium-arsenide-semiconductor-based optical sensor; and
optionally, a mercury-cadmium-telluride-based optical sensor;
optionally, an infrared optical sensor;
optionally, a near infrared optical sensor;
optionally, a visible light sensor;
optionally, an optical sensor mounted on a mobile device (e.g., a smartphone,
tablet, laptop, and/or other mobile device);
optionally, an optical sensor mounted on a Fourier-transform infrared (FTIR)
spectroscopy add-on module for a mobile device;
optionally, an optical sensor for an article and/or article sorting scanner, where:
optionally, the sorting scanner light source is paired with a rotating mirror to
generate a multi-angle and/or rotating illumination pattern.
28. The device of example 25 or any of the other examples in this table, where
the scanning circuitry includes circuitry to implement: spectroscopy using the
illuminator and the optical sensor, where:
optionally, the spectroscopy includes Fourier-transform infrared (FTIR)
spectroscopy; and
optionally, the spectroscopy includes visible-light spectroscopy.
29. The device of example 25 or any of the other examples in this table, further
including a tunable filter configured to filter output of the illuminator and/or input
to the optical sensor, where:
optionally, the scanning circuitry is configured to tune the tunable filter to perform
the scan.
30. The device of example 25 or any of the other examples in this table, further
including a rotating mirror, where:
optionally, the scanning circuitry is configured to cause optical sensor to perform a
capture timed to the rotation of the rotating mirror to perform the scan.
31. The device of example 25 or any of the other examples in this table where
the device further includes processing circuitry to perform a lookup and/or
otherwise determine the characteristic based on the parameter value, where:
optionally, the processing circuitry is configured to perform the lookup by sending a
query to a database system that maintains records relating parameter value to
article characteristics, the query including the parameter value
optionally, the processing circuitry is configured to decode information encoded in
the optical parameter values to determine the characteristic.
32. A system including:
memory configured to store a data structure relating optical parameter values to
article characteristics; and
processing circuitry configured to:
receive a query including a measured optical parameter value, the
measured optical parameter value measured from an optical response of
an identifier fiber embedded in an article;
reference the measured optical parameter value against the data structure
to determine a corresponding characteristic of the article; and
generate a response to the query, the response identifying the
corresponding characteristic, where:
optionally, the system is in accord with and/or used in accord with any article,
textile, device, system and/or method of any of the other examples in this table.
33. The system of example 32 or any of the other examples in this table, where
the query includes multiple measured optical parameter values including a
measured optical parameter value, where:
optionally, the processing circuitry is further configured to reference the multiple
measured optical parameters value against the data structure without regard to
read order;
optionally, the processing circuitry is further configured to:
identify a portion of the multiple measured optical parameter values
indicating a read orientation of the multiple measured optical parameter
values; and
reference the multiple measured optical parameter values against the data
structure using a read order consistent with the read orientation;
optionally, the processing circuitry is further configured to:
determine an implied read order based on the relative values of the
measured optical parameter values; and
reference the multiple measured optical parameter values against the data
structure using a read order consistent the implied read order;
optionally, the processing circuitry is further configured to:
determine an express read order indicated in the query; and
reference the multiple measured optical parameter values against the data
structure using a read order consistent the express read order; and
optionally, the processing circuitry is further configured to:
determine that the multiple measured optical parameter values include first-
type parameter values and second-type parameter values;
determine a read order for the first-type parameter values indicated by the
second type parameter values; and
reference the first-type optical parameter values against the data structure
using the read order.
34. A method including:
receiving a query including a measured optical parameter value, the measured
optical parameter value measured from an optical response of an identifier fiber
embedded in an article;
referencing the measured optical parameter value against the data structure to
determine a corresponding characteristic of the article; and
generating a response to the query, the response identifying the corresponding
characteristic, where:
optionally, the method is in accord with and/or used in accord with any article,
textile, device, system and/or method of any of the other examples in this table.
35. A method of manufacture including:
based on a characteristic of an article, determining an optical parameter value
assigned as at least a portion of an identifier for the characteristic;
determining a structure pattern and scale factor for a photonic structure, the
photonic structure having an optical response with the optical parameter value
when characterized by the structure pattern and the scale factor; and
fabricating the photonic structure having the optical response by:
fabricating a preform characterized by the structure pattern; and
applying force and heat to the preform to resize the preform in accord with
the scale factor, where:
optionally, the method further includes embedding the photonic structure into the
article;
optionally, the article includes a textile, where:
optionally, the photonic structure is woven, knitted, and/or stitched into the
textile;
optionally, applying force and heat to the preform includes drawing the preform
into a fiber;
optionally, the method of manufacture is in accord with and/or used in accord with
any device, system and/or method of any of the other examples; and
optionally the method of manufacture is used to fabricate, at least in part, any fiber
and/or textile of any of the other examples in this table.
36. The method of example 35 or any of the other examples, where applying
force and heat to the preform includes drawing the preform using a ratio of
preform feed speed to output pull speed proportionate to a square of the scale
factor, where:
optionally, applying force and heat to the preform further includes heating the
preform to a temperature selected to maintain a tension created by the ratio
while preventing breakage due to the tension during drawing.
37. The method of example 35 or any of the other examples in this table,
where:
optionally, applying force and heat to the preform further includes heating the
preform to a temperature above a softening temperature of a material of the
preform;
optionally, applying force and heat to the preform further includes heating the
preform to a temperature below a melting temperature of a material of the
preform; and
38. The method of example 35 or any of the other examples in this table,
fabricating the preform includes:
optionally, stacking component materials of the preform in accord with the
structure pattern;
optionally, rolling a stack of component materials to generate multiple layers
concentric about a center axis of the preform;
optionally, heating a stack of component materials to cause adherence among the
component materials;
optionally, in addition to or lieu of preform creation the fiber may be fabricated
through extrusion, where:
optionally the preform is extruded; and
optionally, direct multi-material extrusion is used to create the fiber without
the preform;
optionally, growing the preform layer-by-layer using vapor and/or thermal
deposition;
optionally, growing the preform layer-by-layer using a sputter and/or spray
deposition;
optionally, rotating the preform during deposition to generate multiple layers
concentric about a center axis of the preform;
optionally, fabricating the preform using a sol-gel technique; and
optionally, fabricating the preform using three-dimensional printing.
39. A system with components configured to implement any feature or any
combination of features in the disclosure.
40. A method including implementing any feature or any combination of
features in the disclosure.
41. A product including:
machine readable media; and
instructions stored on the machine readable media configured to implement the
method of example 40 or any other example in this table, where:
optionally, the instructions are executable;
optionally, the machine readable media is non-transitory; and
optionally, the machine readable media other than a transitory signal.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. An article including:
an identifier fiber embedded in the article; and the identifier fiber; and
a photonic structure within the identifier fiber, the photonic structure having an optical response selected to identify, at least in part, a characteristic of the article, the photonic structure extends along a length of the identifier fiber.

2. The article of claim 1, where the article includes a textile.

3. The article of claim 2, where the identifier fiber is woven among multiple base material fibers of the textile.

4. The article of claim 1, where the characteristic of the article includes:
a base material makeup of the article;
an identity of the article;
an identity of a maker of an article;
a textile recycling sorting reference for the article;
a manufacture date of the article;
an identifier string for the article; and/or
a tracking identifier for logistics.

5. The article of claim 1, where the photonic structure includes a reflector with a selected reflectivity profile.

6. The article of claim 1, where the photonic structure includes a one-dimensional photonic structure running along an axis of the identifier fiber.

7. The article of claim 6, where the photonic structure includes a photonic structure that is radially symmetric around the axis of the identifier fiber.

8. The article of claim 6, where the photonic structure includes a sandwich-type multilayer structure.

9. The article of claim 1, where the photonic structure includes a structure is characterized by a selected optical response to a specific illumination source, where the selected optical response is characterized by one or more parameter values corresponding to a database entry that identifies, at least in part, the characteristic of the article.

10. The article of claim 1, where the photonic structure includes multiple material layers, where:
the multiple material layers include a polymer material layer;
the multiple material layers include a glass material layer;
the multiple material layers include a doped material layer;
the multiple material layers include a metal material layer; and/or
the multiple material layers include a birefringent material layer.

11. The article of claim 1, where the optical response is selected to occur at a portion of the optical spectrum where the article has an absence of optical response features.

12. A method including:
illuminating an article including an identifier fiber to cause an optical response from a photonic structure of the identifier fiber;
capturing the optical response;
determining a parameter value of the optical response dependent on the photonic structure of the identifier fiber, and
performing a look-up using the parameter value to determine a characteristic of the article.

13. The method of claim 12, where illuminating the article includes illuminating the article with an illuminator with an output, at least in part, within the infrared spectrum.

14. The method of claim 12, where capturing the optical response includes scanning an optical filter over a portion of an optical spectrum in which optical responses assigned to article characteristics lie.

15. The method of claim 12, where illuminating the article includes scanning an illuminator over multiple angles of light incidence with the article.

16. The method of claim 12, where capturing the optical response includes mapping the optical response versus frequency and/or wavelength.

17. The method of claim 12, where capturing the optical response includes performing Fourier-transform infrared (FTIR) spectroscopy.

18. The method of claim 12, where performing the look-up using the parameter value to determine the characteristic of the article includes referencing the parameter value against a database that relates parameter values to article characteristics.

19. A device including:
an illuminator configured to illuminate at least a portion of an article, the portion including an identifier fiber embedded in the article;
an optical sensor configured to capture an optical response of the identifier fiber; and
scanning circuitry configured cause the device to perform a scan to determine a parameter value of the optical response, the parameter value of the optical response tuned to identify a characteristic of the article.

20. The device of claim 19, further including a rotating mirror, where:
the scanning circuitry is configured to cause optical sensor to perform a capture timed to the rotation of the rotating mirror to perform the scan.
